(19) United States
(12) Patent Application Publication
(10) Pub. No.: US 2012/0012067 A1
(43) Pub. Date: Jan. 19, 2012

(54) Pet toy

(75) Inventors: Kimberly A. Stout, Alliance, OH (US); Robert C. Holt, JR., North Canton, OH (US)

(73) Assignee: Coastal Pet Products, Inc.

(21) Appl. No.: 12/804,180

(22) Filed: Jul. 16, 2010

(51) Int. Cl. A01K 29/00

(52) U.S. Cl. 119/707

(57) ABSTRACT

A pet toy (10) includes a fabric body (11) and a resilient insert (18) having a hub (19) positioned in the body (11). The hub (19) is surrounded by a fluff material (21) in the body (11) and a plurality of appendages (14) extend from the hub (19) out of the body (11).

### TECHNICAL FIELD

This invention relates to a toy for pets. More particularly, this invention relates to such a toy made of a plush fabric material and a rubber-like material such as latex.

### BACKGROUND ART

Toys for dogs and other pets typically take on several configurations. One popular configuration is that of an animal or insect with appendages such as legs. Ideally, the body of the toy can be made of a plush fabric material, and the appendages have typically been made of a vinyl material both of which can be chewed upon by the pet. However, the vinyl appendages are usually glued or similarly connected to the fabric body, and even the least active pets will often destroy the toy by severing the appendages from the body.

The need exists, therefore, for a pet toy which is made of a plush fabric and rubber-like resilient material which simulates the configuration of an animal or insect, and which will hold up even under the rigors generated by very active pets.

### DISCLOSURE OF THE INVENTION

It is thus an object of one aspect of the present invention to provide a durable pet toy made of a fabric and resilient material.

It is an object of another aspect of the invention to provide a pet toy, as above, in which the resilient material will not separate from the fabric material even under strenuous pet usage.

These and other objects of the present invention, as well as the advantages thereof over existing prior art forms, which will become apparent from the description to follow, are accomplished by the improvements hereinafter described and claimed.

In general, a toy includes a body member made of a fabric material and an insert carried by the body member. The insert is made of a resilient material and includes a hub positioned totally within the body member and a plurality of appendages extending from the hub and out of the body member.

A preferred exemplary pet toy according to the concepts of the present invention is shown by way of example in the accompanying drawings without attempting to show all the various forms and modifications in which the invention might be embodied, the invention being measured by the appended claims and not by the details of the specification.

### BRIEF DESCRIPTION OF THE DRAWINGS

FIG. 1 is a plan view of a pet toy made in accordance with the present invention.

FIG. 2 is a plan view of the resilient, rubber-like component of the pet toy of FIG. 1.

FIG. 3 is a side elevational view of the resilient, rubber-like component shown in FIG. 2.

FIG. 4 is a sectional view taken substantially along line 4-4 of FIG. 1.

FIG. 5 is a plan view of an alternate configuration of the resilient, rubber-like component of the pet toy of FIG. 1.

FIG. 6 is a plan view of another alternate configuration of the resilient, rubber-like component of the pet toy of FIG. 1.

FIG. 7 is a plan view of yet another alternate configuration of the resilient, rubber-like component of the pet toy of FIG. 1.

### PREFERRED EMBODIMENTS FOR CARRYING OUT THE INVENTION

A pet toy made in accordance with the present invention is generally indicated by the numeral 10. The pet toy as shown is generally in the form of an insect, such as a ladybug. As such, it includes a body, generally indicated by the numeral 11, having spots 12 thereon, a head 13, and a plurality of appendages 14. In this instance the appendages 14 simulate the legs of the insect; however, in other instances the appendages could represent other items. Moreover, a pet toy 10 in accordance with the invention need not take on the configuration of an insect. For example, pet toy 10 could be in the form of an animal, such as a rodent, or even in the form of a human, as long as it included a body and some type of appendages.

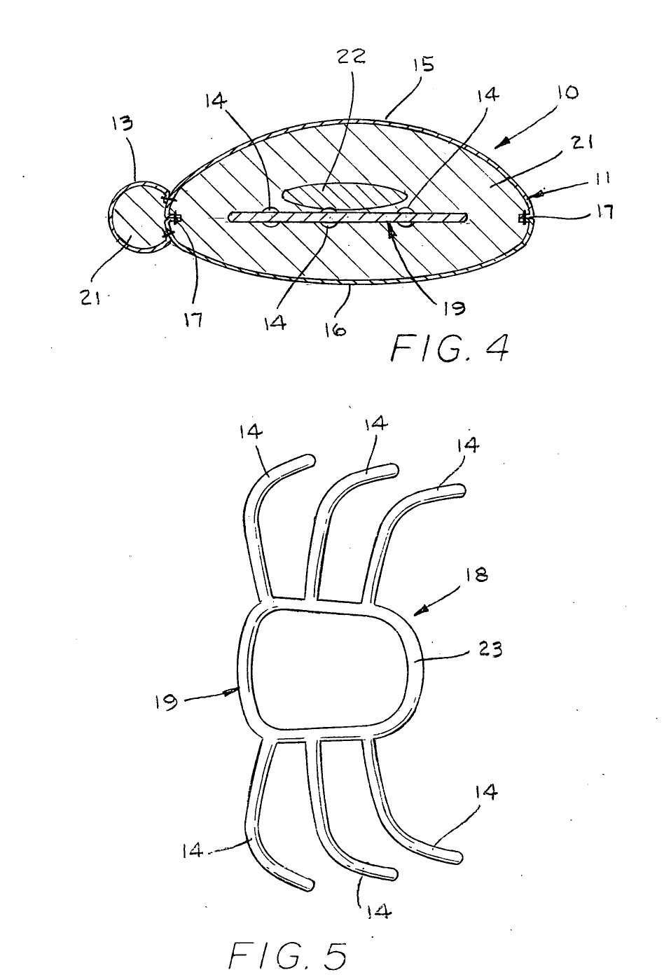

Body 11 and head 13 of pet toy 10 are made of a fabric or plush material and are preferably formed of the least two segments, an upper portion 15 and a lower portion 16, which are sewn together at generally the general center of toy 10, as at 17 (see FIG. 4).

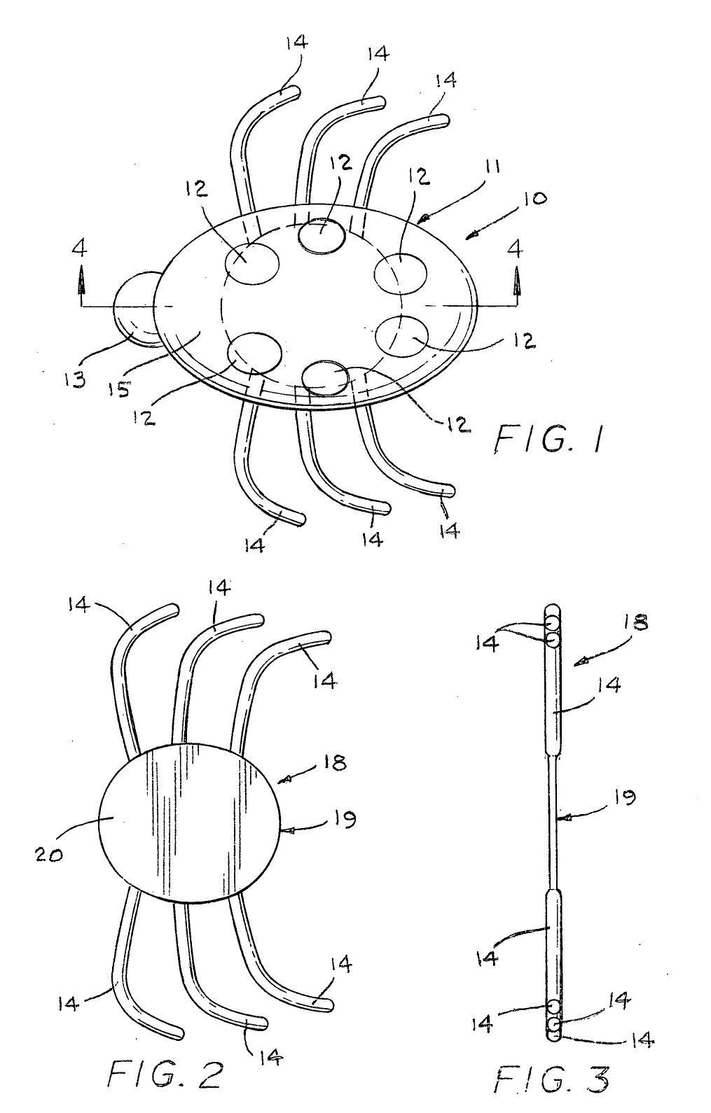

Appendages 14 are part of an insert structure, that includes a central hub generally indicated by the numeral 19. Hub 19 and appendages 14 are integrally molded of any resilient, natural or synthetic, rubber-like material such as latex, silicone, thermoplastic rubber and the like. As shown in FIG. 3, hub 19 may be formed thinner than appendages 14 to thereby save material without a loss of strength inasmuch as the thicker appendages are the portions of insert 18 that will withstand the abuse of the animal. Hub 19 is shown in FIG. 2 as being a solid disk 20. However, as will hereinafter be described in more detail, hub 19 may take on essentially any configuration which will hold appendages 14.

Central hub 19 of insert structure 18 is positioned totally within the body 11 of toy 10. Hub 19 is surrounded by a soft fluff material 21, such as a cotton-like polyester, which fills body 11 and head 12. As such, hub 19 floats in the material 21. A conventional squeaker 22 may also be provided in the fluff material 21 so that the toy 10 can make a noise if squeaker 22 is compressed.

It should be evident that toy 10 may be assembled by placing hub 19 and squeaker 22 in an appropriate amount of fluff material 21 and then covering it with upper fabric portion 15 and lower fabric portion 16. The portions 15, 16 are then attached, as by sewing as previously described. In so doing, the portions 15, 16 are sewn around appendages 14 such that they will pass through body 11. However, if a pet strenuously stretches appendages 14, they will not separate from body 11 as is the case with the prior art. Rather, appendages may merely stretch from hub 19 and resiliently return to their normal condition when the strenuous activity ceases.

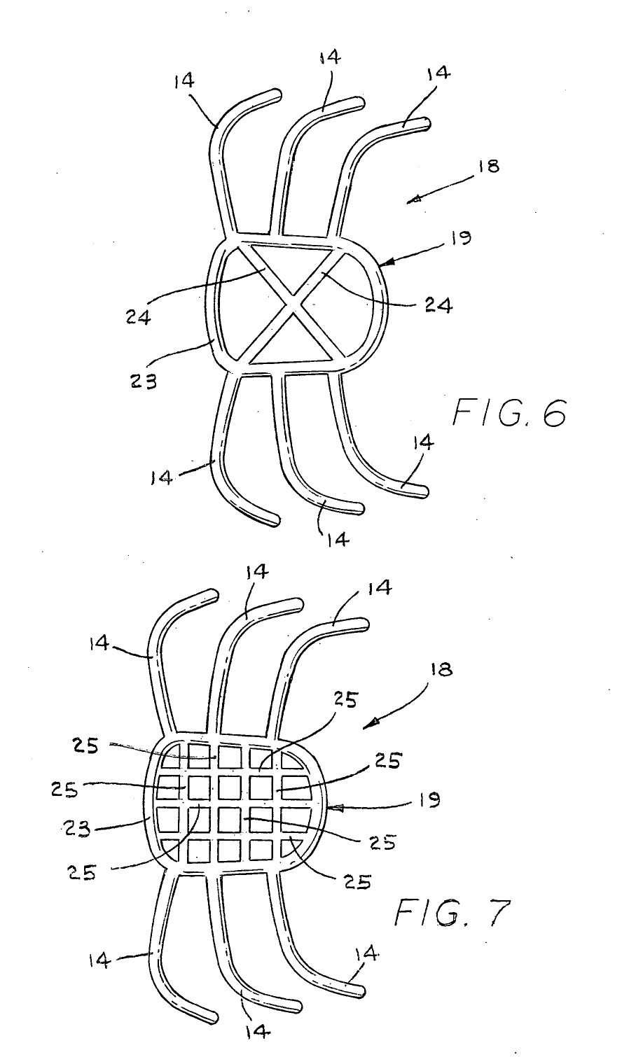

Alternate forms of hubs 19 of insert structures 18 are shown in FIGS. 5-7. For example, instead of being a solid disk 20, hub 19 may merely be a strip of material forming a closed loop 23 to which appendages 14 are formed. Or as shown in FIGS. 6 and 7 the loop 23 could be formed with diagonal intersection cross members 24 or horizontal and vertical intersecting members 25. In short, hub 19 could be formed of a wide myriad of configurations without departing from the concepts of the present invention.

In view of the foregoing, it should thus be evident that a pet toy constructed as described herein accomplishes the objects of the present invention and otherwise substantially improves the art.

What is claimed is:

1. A toy comprising a body member made of a fabric material, and an insert carried by said body member, said insert being made of a resilient material and including a hub positioned totally within said body member and a plurality appendages extending from said hub and out of said body member.

2. The toy of claim 1 further comprising a fluff material generally filling said body member and surrounding said hub.

3. The toy of claim 1 wherein said body member is made of at least two segments, said segments being sewn together.

4. The toy of claim 1 wherein said hub is thinner than said appendages.

5. The toy of claim 1 wherein said body member is configured as the body of an insect and said appendages are configured as the legs of the insect.

6. The toy of claim 5 further comprising a portion configured as the head of an insect connected to said body member.

7. The toy of claim 6 wherein said appendages are configured as the legs of the insect.

8. The toy of claim 7 further comprising a fluff material generally filling said body member and surrounding said insert.

9. The toy of claim 8 further comprising a squeaker in said body member.

10. The toy of claim 1 wherein said hub is in the form of a solid disk.

11. The toy of claim 1 wherein said hub is in the form of a loop.

12. The toy of claim 1 wherein said hub is in the form of a loop having intersecting members within said loop.

13. The toy of claim 1 wherein said insert is made of a latex material.
